(19) United States
(12) Patent Application Publication
(10) Pub. No.: US 2009/0253100 A1
(43) Pub. Date: Oct. 8, 2009

(54) METHOD AND APPARATUS FOR MANUFACTURING ORTHODONTIC APPLIANCES

(75) Inventors: Andrew McCance, West Sussex (GB); Joe Caprani, West Sussex (GB)

Correspondence Address: STEPTOE & JOHNSON LLP, 2121 AVENUE OF THE STARS, SUITE 2800, LOS ANGELES, CA, 90067, US

(73) Assignee: ORTHO-PRO-TEKNICA LIMITED, East Grinstead, West Sussex (GB)

(21) Appl. No.: 12/159,588

(22) PCT Filed: Dec. 28, 2006
(86) PCT No.: PCT/GB2006/004945

§ 371 Date: Oct. 3, 2008

(30) Foreign Application Priority Data
Dec. 30, 2005 (GB) 0526608.5

(51) Int. Cl. A61C 13/10; A61C 19/06

(52) U.S. Cl. 433/196; 29/896.11

(57) ABSTRACT

The invention provides a method of manufacturing a series of tooth positioners for incrementally repositioning one or more teeth of a patient from an initial configuration to a final configuration via one or more intermediate configurations. The method uses a composite model of the patient's teeth in the initial configuration, the composite model having a base and one or more discrete model teeth. Each model tooth includes a crown portion and a root portion and is mounted on the base in a tooth mounting portion of the base formed from a mounting material in which the root portion can be imbedded and retained in position but which can allow movement of the root portion through the tooth mounting portion upon application of a force to the crown portion of the model tooth. In the method, the position of one or more of the model teeth is changed to reconfigure the composite model to a first intermediate configuration. A negative impression of the first intermediate tooth configuration is then made. The position of one or more of the model teeth in the mounting portion of the base is then changed again to reconfigure the composite model to a second intermediate or a final configuration. A second or final impression of the second intermediate or final tooth configuration is then produced. The impressions taken from the model can be used to make the series of positioners.

### FIELD OF THE INVENTION

The present invention relates generally to the field of orthodontics and more specifically to methods and apparatus for the manufacture of orthodontic appliances that can be used to reposition teeth.

### BACKGROUND

Repositioning teeth to correct malocclusions (i.e. faulty contact between upper and lower teeth) is desirable for functional as well as aesthetic reasons. Uneven distribution of masticatory forces, for example, can result in excessive wear and loosening of teeth and crowding of teeth can mean cleaning is more difficult leading to increased plaque and greater susceptibility to caries.

Conventionally, malocclusions are corrected through the use of orthodontic appliances, commonly known as “braces”, that include a series of metal or ceramic attachments that are cemented to the teeth and connected by tensioned wires that apply forces to the attachments, and hence to the teeth, to give the desired movement. These conventional appliances are, however, not without problems. The procedures for attaching the appliances to the teeth are not straightforward and can cause discomfort, as can the installed appliance. These appliances are generally unsightly and cause problems themselves in maintaining dental hygiene, with the attachments acting as traps for food as it is chewed.

Tooth positioners are an alternative to conventional metal braces that have gained in popularity in recent years.

The concept was first proposed in the 1940's by Dr. Harold Kesling as an appliance for the final positioning of teeth following use of more conventional orthodontic appliances (see:

Kesling, “The Philosophy of the Tooth Positioning Appliance”, Am. J. Orthod. Oral. Surg. (1945) 31(6):297-304). Kesling proposed a positioner made of a resilient deformable rubber that had opposed ‘U’-shape channels moulded to fit over the occlusal and incisal surfaces of the upper and lower arches respectively, applying forces to the teeth to influence their position as well as to maintain a desired relationship between the upper and lower arches. Kesling's positioners are also described in his U.S. Pa. No. 2,531,222 and another early example of a tooth positioner is seen in GB 1550777 (Suyehiro).

It is only much more recently, however, that positioners have been proposed as a realistic alternative to conventional metal braces. Recent examples of tooth positioners include those provided by Ortho-Pro-Teknica Ltd under the brand name ClearStep™ and by Align Technology, Inc. under the brand name Invisalign™.

These positioners are moulded polymeric trays or shells of generally U-shape form that fit over the teeth of the upper or lower arch. They are colourless and transparent so are aesthetically much improved compared with the conventional braces. A realignment of the teeth is achieved by using a series of positioners, each positioner typically to be worn for a period of several weeks, to incrementally reposition the teeth. The positioners can be removed by the patient themselves to allow their teeth to be cleaned avoiding the dental hygiene problems associated with the fixings of metal braces.

Align Technology describe in their U.S. Pat. No. 5,975,893 a process by which a series of moulded polymeric tooth positioners can be produced. In this process, a digital model of the patients initial (malformed) tooth arrangement is obtained by laser scanning a plaster cast of the patient's teeth obtained in a conventional manner. The digital model is manipulated to produce a final tooth arrangement (i.e. with the teeth correctly positioned with respect to one another) and, through a number of complex computations, the system creates a series of intermediate tooth arrangements representing the incremental steps in the tooth repositioning process. Rapid prototyping methods are then used to create a corresponding series of ‘positive’ tooth moulds, one for each intermediate tooth arrangement and one for the final tooth arrangement, on which the positioners themselves can be formed. This approach requires a trade off between the level of detail in the digital models and the computational overheads when creating the digital models of the final and intermediate teeth arrangements. Any discrepancies in the model compared with the patient's teeth will likely be compounded as the model is digitally manipulated.

### SUMMARY OF INVENTION

It is a general aim of the present invention to provide methods and apparatus for manufacturing orthodontic appliances, in particular moulded tooth positioners that accurately conform to a patient's teeth without the reliance on complex computational steps and the computer processing overheads that entails.

In a first aspect, the present invention provides a method of manufacturing a series of tooth positioners for incrementally repositioning one or more teeth of a patient from an initial configuration to a final configuration via one or more intermediate configurations, the method comprising:

providing a composite model of the patient's teeth in the initial configuration, the composite model comprising a base and one or more discrete model teeth, the or each model tooth including a crown portion and a root portion and being mounted on the base in a tooth mounting portion of the base formed from a mounting material in which the root portion can be imbedded and retained in position but which can allow movement of the root portion through the tooth mounting portion upon application of a force to the crown portion of the model tooth;

changing the position of one or more of the model teeth in the mounting portion of the base to reconfigure the composite model to a first intermediate configuration;

producing a first negative impression of the first intermediate tooth configuration;

subsequently further changing the position of one or more of the model teeth in the mounting portion of the base to reconfigure the composite model to a second intermediate or a final configuration; and

producing a second or final impression of the second intermediate or final tooth configuration.

In another aspect the invention provides a composite model for modelling multiple configurations of a patient's teeth, the composite model comprising:

a base; and

one or more discrete model teeth;

the or each model tooth including a crown portion and a root portion and being mounted on the base in a tooth mounting portion of the base formed from a mounting material in which the root portion can be imbedded and retained in position but which can allow movement of the root portion through the tooth mounting portion upon application of a force to the crown portion of the model tooth.

In this way, by using discrete model teeth having root portions, the movements of the model teeth within the mounting material are constrained closely to what is feasible in the actual patient and the positioners that are manufactured based on the composite model are more likely to achieve the modelled movements of the teeth.

The root portion of the model tooth preferably tapers away from the crown portion so that it is narrower than the crown portion in at least one dimension at its end distal the crown portion. The root portion is preferably at least 25% of the length of the model tooth, more preferably at least 35% and may extend 50% or 75% or more of the overall length of the tooth (i.e. be the same length as or longer than the crown portion).

Preferably the mounting portion is provided by a contiguous region of the mounting material in which two or more model teeth (preferably all of the teeth that it is planned to move) can be imbedded. In this way the movement of the root portions as well as the crown portions of each tooth is constrained to some degree by the root portions of adjacent model teeth, placing more realistic constraints on the extent of possible movements in any one incremental step in the procedure.

Preferably the mounting material is a thermoplastic material to allow the desired movement of the root portion in a controlled manner. The material may be chosen so that it can be softened to allow the desired movements of the teeth, whilst still retaining them, and subsequently hardened (preferably at room temperature) to more securely hold the teeth in place between successive incremental movements. For instance, the mounting material may be wax that can, for example, be softened by gentle heating and subsequently harden as it cools.

The model teeth can be made from any of a number of suitable materials, including for example a gypsum derivative or, more preferably a polymeric material.

The base and the model teeth can be formed initially as a single casting, e.g. of a gypsum derivative or a suitable polymeric material, using an impression of the patient's upper or lower arch in a conventional manner. The teeth that it is planned to move can then be separated from the casting, for example using a surgical saw, to form the model teeth. As the crown portion of each model tooth is formed using an impression of the corresponding tooth of the patient it is a very accurate replica. The root portion of the model tooth can be formed into the desired shape using a file or grinding wheel for example.

To create the composite model, the model teeth are first located in the original impression obtained from the patient's teeth, or more preferably a further ‘negative’ mould (i.e. impression) taken from the casting before the teeth are separated from it. The mounting material is then applied over the model teeth, covering the root portions (for example, where the moulding material is wax it can be melted and poured over the model teeth). The remainder of the casting left after the model teeth have been removed can be re-located in the impression before the mounting material is applied or fresh casting material subsequently added to the impression/negative mould to form the base of the composite model. Assuming not all of the patient's teeth are to be moved in the planned treatment, this base portion may include replicas of one or more of the crowns of others of the patient's teeth. The composite model can then be extracted from the impression/negative mould, having been allowed to first harden if needs be. In this way, the composite model represents a very accurate, detailed model of the patient's teeth arch in its initial, malformed configuration.

After each movement of the model to the next intermediate (or final) configuration of the teeth, as noted above, an impression or negative mould of the teeth arch of the model is formed. This can then be used to create a positive mould, for example of a gypsum derivative or a suitable polymeric material, over which the polymeric positioners themselves can be moulded. The positioners may, for example, be vacuum formed over the positive mould. One suitable material for the positioners is PET.

In preferred embodiments of the present invention, the composite model is used to manufacture three or more positioners, more preferably four, five or six or more, and potentially seven or eight or even more positioners that can then be provided as a batch to the patient for sequential use to reposition the patient's teeth from an initial configuration to a final configuration via a series of incremental configurations.

There is in principal no limit to the number of incremental movements of the composite model and the corresponding number of positioners produced from the model but in practice it has been found that from a clinical perspective a maximum of eight to twelve movements is desirable. For some patients a treatment program using a series of eight positioners will be adequate to achieve the desired results. For other, one or more further treatments with e.g. a further eight positioners may be needed. In such cases it is preferred to take a fresh impression from the patient and the create a new composite model.

### BRIEF DESCRIPTION OF DRAWINGS

Embodiments of the invention will now be described, by way of example only, with reference to the accompanying drawings, in which:

FIG. 1 shows a composite model in accordance with an embodiment of the present invention;

FIGS. 2a to 2i illustrate the steps in the manufacture of the composite model of FIG. 1;

FIG. 3a to 3f illustrate the steps in the manufacture of a positioner using the composite model of FIG. 2; and

FIG. 4 is a process flow diagram illustrating the overall process of manufacturing the composite model and using it to manufacture a series of positioners.

### DESCRIPTION OF EMBODIMENT

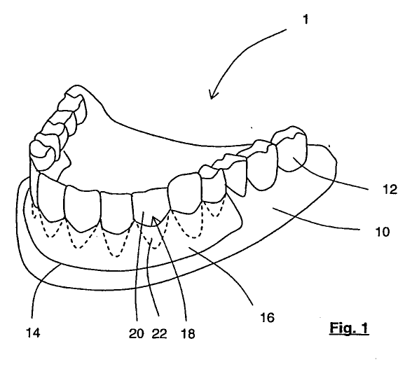

FIG. 1 shows a composite model 1 in accordance with an embodiment of the present invention. In this example the model is for a patient's lower complete set of teeth (mandibular arch). A similar model can be produced for the upper set of teeth (maxial arch) or for selected portions of one or other of the arches only.

The model comprises a base 10 that can be a gypsum derivative or a polymeric material for instance. In this example the rear three teeth 12 on each side of the arch are retained as an integral part of the base 10 as the planned treatment does not include any movement of these teeth. Depending on the planned movement, more or fewer (or even no) teeth 12 may be formed integrally with the base 10.

At the forward part of the base 10 there is a recessed portion 14 into which a mounting material, in this example wax 16, is moulded to model the gum and underlying bone of the mandible in which the teeth that are to be moved are supported.

The teeth that are to be moved during the planned treatment are represented in the model by discrete model teeth 18, each of which has a crown portion 20 and a root portion 22. The root portion 22 is imbedded in and retained by the wax mounting material 16.

In use, tooth movements within the model are achieved by warming the wax 16 (e.g. by immersing the composite model in a bath of hot water) to soften it. Once the wax 16 Is sufficiently softened to allow some movement of the root portions of the teeth within it, whilst still retaining the model tooth 18, one or more of the model teeth 18 can be manipulated to modify their position in accordance with the planned treatment. The wax 16 provides resistance to movement of the root 22. The presence of the root 22 as part of the tooth model serves to constrain the possible movements to more realistically represent what is possible in the patient.

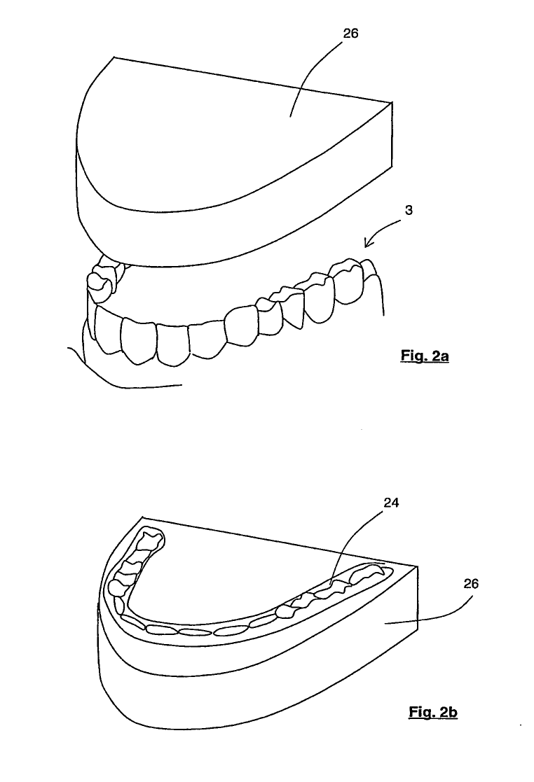

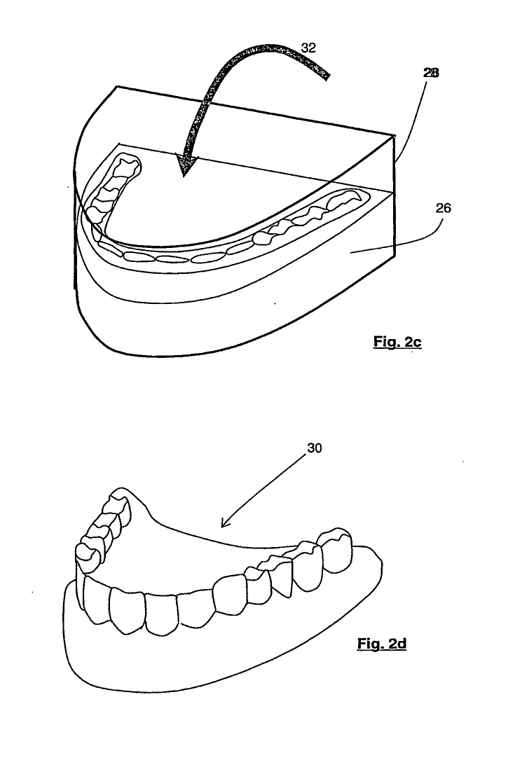

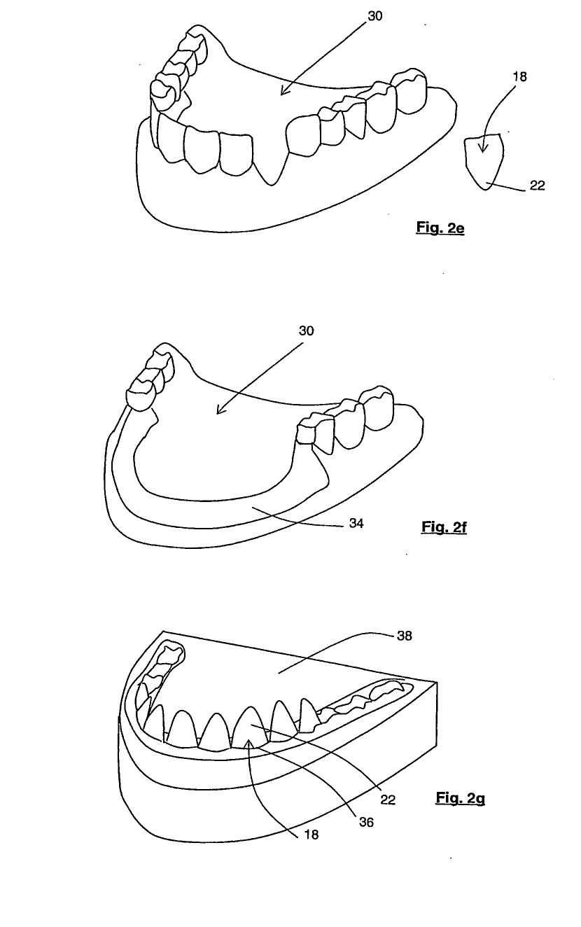

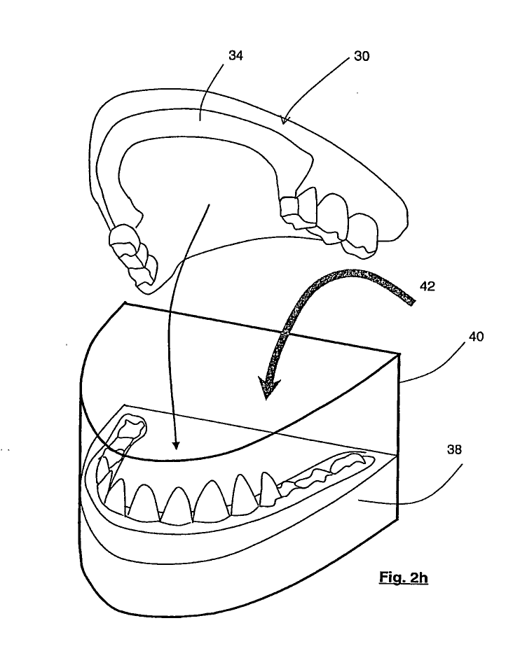

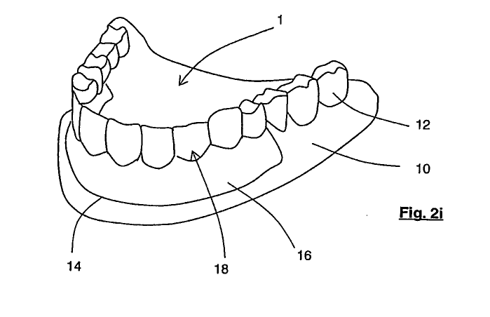

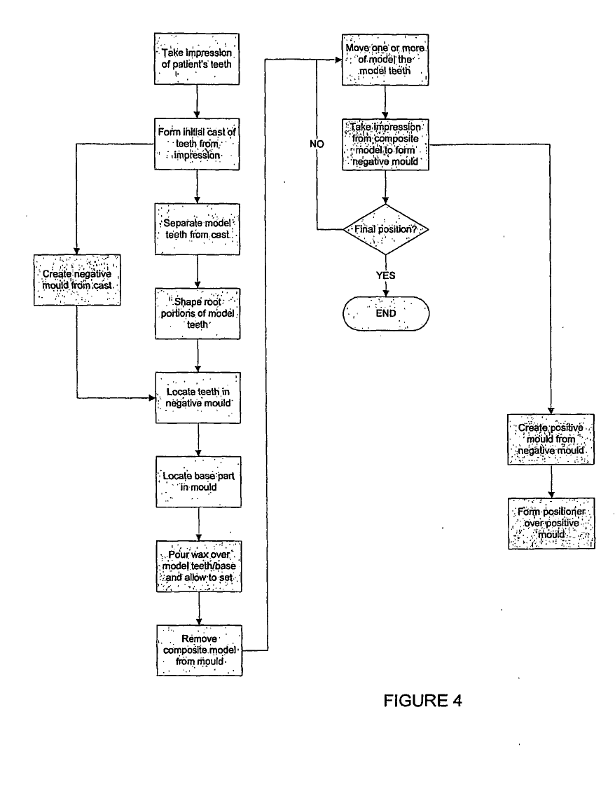

FIG. 4 illustrates the process by which the composite model 1 of FIG. 1 is manufactured and then used to manufacture a series of polymeric positioners 2. The process for manufacturing the model will be described first, with reference also to FIGS. 2a to 2h.

The starting point is an impression 24 of the patient's teeth 3 (in this case the lower arch) made in an impression block 26 (see FIGS. 2a and 2b). As shown in FIGS. 2c and 2d, the impression block 26 is placed in a container 28, and an initial cast 30 is formed by pouring e.g., a gypsum derivative or polymeric material into the container 28, as indicated by arrow 32. The model teeth 18 that it is planned to move are separated from the initial cast 30 and their root portions 22 shaped, as shown in FIG. 2e. Accordingly, a recess portion 34 is left in the initial cast 30, as shown in FIG. 2f. By forming discrete tooth models 18 for each tooth in this way the movements possible in the model 1 closely reflect those possible in the patient.

The composite model 1 is then assembled. As shown in FIG. 2g, first the model teeth 18 are located in their respective cavities 36 in a negative mould 38 created by taking an impression from the initial cast 30 (alternatively, the original impression 24 may be used). With reference to FIG. 2h, the negative mould 38 is placed in a container 40, the model base 10 (formed by re-using the remainder of the initial cast 30 from which the teeth 18 have been cut) is inserted into the mould and the mounting material, in this example wax 16, is melted and poured over into the mould to cover the root portions, as indicated by arrow 42. In combination the model teeth 18, wax mounting part 16 and gypsum derivative/polymeric material base 10 are a complete replica of the initial cast 30. The composite model 1, as shown in FIG. 2i, is then ready for use.

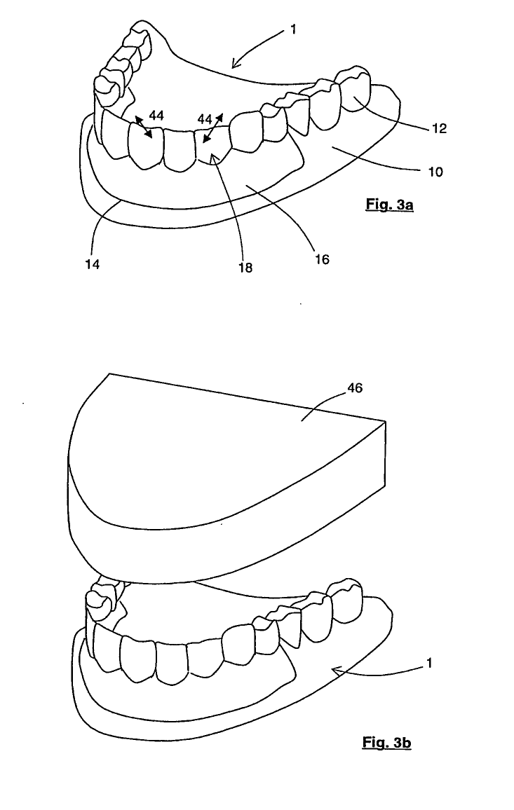

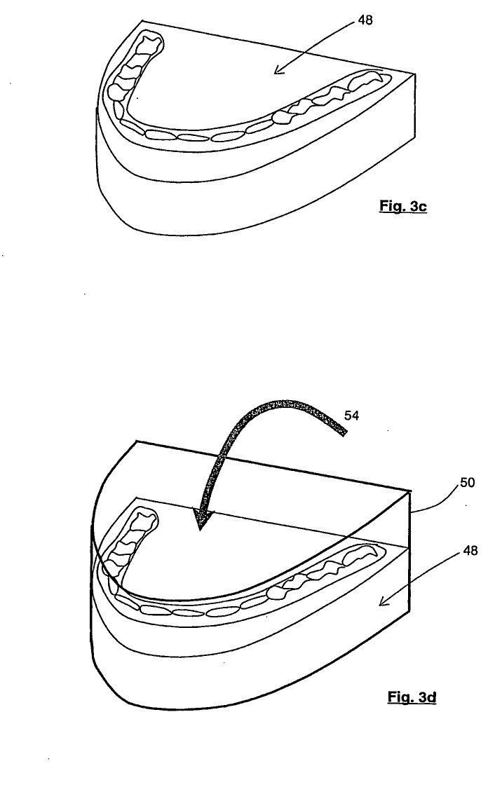

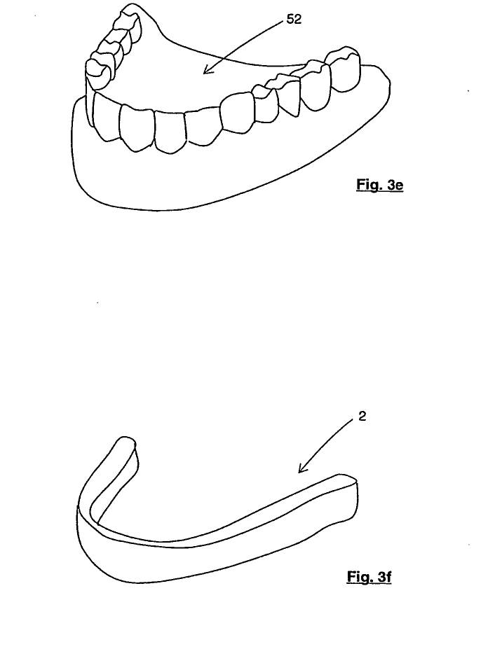

To form the desired series of positioners, as illustrated in FIGS. 3a to 3f and FIG. 4, the composite model 1 is heated (e.g. in a bath of hot water (not shown)) to soften the wax 16.

One or more of the model teeth 18 can then be repositioned, as indicated by arrows 44 in FIG. 3a, and the wax 16 allowed to harden to retain the model teeth 18 in their new configuration. In general, each tooth 18 that is moved will not be moved by more than 0.25 to 0.5 mm at most in any one increment of the model.

With reference to FIGS. 3b and 3c, once the wax 16 is set, an impression of the composite model with the teeth in the new configuration is taken in an impression block 46 to create a negative mould 48 of the first intermediate tooth configuration. The negative mould 48 is then placed in a container 50, as shown in FIG. 3d, and a positive mould 52 is formed by pouring e.g., gypsum derivative or polymeric material into the container 50, as indicated by arrow 54. This positive mould 52 (see FIG. 3e) is for the first intermediate tooth configuration, and the first positioner 2 (illustrated in FIG. 3f) in the planned series is formed over this positive mould 52, for example by vacuum forming. The positioners 2 are preferably formed from a transparent polymeric material.

Meanwhile, the model 1 can be heated once more and a second movement of teeth carried out. The second movement may involve moving the same teeth as the first movement and/or one or more of the other model teeth. Another impression can then be taken to create a negative mould for the second intermediate tooth configuration, which is used in the same manner as the first one to create a positive mould and then a second positioner in the series.

This process is repeated until a complete series of positioners for the planned treatment has been manufactured. Generally, there will be eight positioners in the series. The series of positioners can then be provided to the patient to be used in sequence to incrementally move the patient's teeth from the initial configuration to a final configuration (for the particular course of treatment—further courses may follow) via several intermediate configurations.

1. A method of manufacturing a series of tooth positioners for incrementally repositioning one or more teeth of a patient from an initial configuration to a final configuration via one or more intermediate configurations, the method comprising:
providing a composite model of the patient's teeth in the initial configuration, the composite model comprising a base and one or more discrete model teeth, the or each model tooth Including a crown portion and a root portion and being mounted on the base in a tooth mounting portion of the base formed from a mounting material in which the root portion can be imbedded and retained in position but which can allow movement of the root portion through the tooth mounting portion upon application of a force to the crown portion of the model tooth;
changing the position of one or more of the model teeth in the mounting portion of the base to reconfigure the composite model to a first intermediate configuration;
producing a first negative impression of the first intermediate tooth configuration;
subsequently further changing the position of one or more of the model teeth in the mounting portion of the base to reconfigure the composite model to a second intermediate or a final configuration; and
producing a second or final impression of the second intermediate or final tooth configuration.

2. A composite model for modelling multiple configurations of a patient's teeth, the composite model comprising:
a base; and
one or more discrete model teeth;
the or each model tooth including a crown portion and a root portion and being mounted on the base in a tooth mounting portion of the base formed from a mounting material in which the root portion can be imbedded and retained in position but which can allow movement of the root portion through the tooth mounting portion upon application of a force to the crown portion of the model tooth.

3. A composite model according to claim 1, comprising at least one model tooth having a root portion that tapers away from the crown portion so that it is narrower than the crown portion in at least one dimension at its end distal the crown portion.

4. A composite model according to claim 3, wherein the root/portion is at least 25% of the length of the model tooth.

5. A composite model according to claim 3, wherein the root portion is at least 50% of the overall length of the tooth.

6. A composite model according to any one of the preceding claims, wherein the mounting portion is provided by a contiguous region of the mounting material in which two or more model teeth can be imbedded.

7. A composite model according to any one of the preceding claims, wherein the mounting material is a thermoplastic material

8. A composite model according to claim 7, wherein the thermoplastic material can be softened by heating to allow the desired movements of the teeth, whilst still retaining them, and subsequently hardened at room temperature to more securely hold the teeth in place between successive incremental movements.

9. A composite model according to any one of the preceding claims, wherein the model teeth are made from a polymeric material.
